(19) United States
(12) Patent Application Publication
(10) Pub. No.: US 2014/0359434 A1
(43) Pub. Date: Dec. 4, 2014

(54) PROVIDING OUT-OF-DICTIONARY INDICATORS FOR SHAPE WRITING

(71) Applicant: Microsoft Corporation, Redmond, WA (US)

(72) Inventors: Juan Dai, Sammamish, WA (US); Timothy S. Paek, Sammamish, WA (US); Dmytro Rudchenko, Bellevue, WA (US); Parthasarathy Sundararajan, Bellevue, WA (US); Eric Norman Badger, Redmond, WA (US); Pu Li, Sammamish, WA (US)

(21) Appl. No.: 13/906,250

(22) Filed: May 30, 2013

(51) Int. Cl. G06F 17/28; G06F 17/24; G06F 3/0488

(52) U.S. Cl. CPC G06F 17/28; G06F 3/0488; G06F 17/24
USPC 715/259

(57) ABSTRACT

Disclosed herein are representative embodiments of tools and techniques for providing out-of-dictionary indicators for shape writing. According to one exemplary technique, a first shape-writing shape is received by a touchscreen and a failed recognition event is determined to have occurred for the first shape-writing shape. Also, a second shape-writing shape is received by the touchscreen and a failed recognition event is determined to have occurred for the second shape-writing shape. The first shape-writing shape is compared to the second shape-writing shape. Additionally, at least one out-of-dictionary indicator is provided based on the comparing of the first shape-writing shape to the second shape-writing shape.

### BACKGROUND

Mobile devices with capacitive or resistive touch capabilities are well known. Mobile phones have evolved over the years to the point where they possess a broad range of capabilities. They are not only capable of placing and receiving mobile phone calls, multimedia messaging (MMS), and sending and receiving email, they can also access the Internet, are GPS-enabled, possess considerable processing power and large amounts of memory, and are equipped with high-resolution displays capable of detecting touch input. As such, some of today's mobile phones are general purpose computing and telecommunication devices capable of running a multitude of applications. For example, some modern mobile phones can run word processing, web browser, media player and gaming applications.

As mobile phones have evolved to provide more capabilities, various user interfaces have been developed for users to enter information. In the past, some traditional input technologies have been provided for inputting text, however, these traditional text input technologies are limited.

### SUMMARY

Among other innovations described herein, this disclosure presents various embodiments of tools and techniques for providing out-of-dictionary indicators for shape writing. According to one exemplary technique, a first shape-writing shape is received by a touchscreen and a failed recognition event is determined to have occurred for the first shape-writing shape. Also, a second shape-writing shape is received by the touchscreen and a failed recognition event is determined to have occurred for the second shape-writing shape. The first shape-writing shape is compared to the second shape-writing shape. Additionally, at least one out-of-dictionary indicator is provided based on the comparing of the first shape-writing shape to the second shape-writing shape.

According to an exemplary tool, a first shape-writing shape is received by a touchscreen, and based on the first shape-writing shape, first recognized text is automatically provided in a text edit field. A failed recognition event is determined to have occurred for the first shape-writing shape at least by determining that the first recognized text is deleted from the text edit field. Also, a second shape-writing shape is received by the touchscreen, and based on the second shape-writing shape, second recognized text is automatically provided in the text edit field. A failed recognition event is determined to have occurred for the second shape-writing shape at least by determining that the second recognized text is deleted from the text edit field. The first shape-writing shape is compared with the second shape-writing shape and based on the comparing the first shape-writing shape to the second shape-writing shape, at least one visual out-of-dictionary indicator is displayed in a display of a computing device. After the comparing that the first shape-writing shape to the second shape-writing shape, entered text is received as input to the text edit field and the entered text is added to a text suggestion dictionary.

This summary is provided to introduce a selection of concepts in a simplified form that are further described below. This summary is not intended to identify key features or essential features of the claimed subject matter, nor is it intended to be used to limit the scope of the claimed subject matter. The foregoing and other objects, features, and advantages of the technologies will become more apparent from the following detailed description, which proceeds with reference to the accompanying figures.

### BRIEF DESCRIPTION OF THE DRAWINGS

FIGS. 1A, 1B and 1C are diagrams of an exemplary computing device that can provide at least one out-of-dictionary indicator based at least on comparing received shape-writing shapes.

FIG. 2 is a flow diagram of an exemplary method for providing at least one out-of-dictionary indicator based at least on comparing received shape-writing shapes.

FIG. 3 is a diagram of an exemplary computing device providing out-of-dictionary indicators.

FIGS. 4A, 4B, and 4C are diagrams of an exemplary computing device that can add entered text to a text suggestion dictionary for shape-writing recognition after providing at least one out-of-dictionary indicator.

FIGS. 5A and 5B are diagrams of an exemplary computing device that can add entered text into a text suggestion dictionary for shape-writing recognition after providing at least one out-of-dictionary indicator and then recommending the entered text as a text recommendation.

FIGS. 6A, 6B, 6C, and 6D are diagrams of an exemplary computing device for providing at least one out-of-dictionary indicator after at least one failed recognition event and adding entered text to a text suggestion dictionary.

FIG. 7 is a flow diagram of an exemplary method for providing at least one out-of-dictionary indicator and adding entered text to a text suggestion dictionary.

FIG. 8 is a schematic diagram illustrating an exemplary mobile device with which at least some of the disclosed embodiments can be implemented.

FIG. 9 is a schematic diagram illustrating a generalized example of a suitable implementation environment for at least some of the disclosed embodiments.

FIG. 10 is a schematic diagram illustrating a generalized example of a suitable computing environment for at least some of the disclosed embodiments.

### DETAILED DESCRIPTION

This disclosure presents various representative embodiments of tools and techniques for providing one or more out-of-dictionary indicators. In some implementations, during text entry through shape writing using a touchscreen, a user can be notified via a provided out-of-dictionary indicator that a word or other text is not included in a text suggestion dictionary for shape writing. In some implementations, the user can then enter the text into a text edit field and the text can be automatically added to the text suggestion dictionary. In some implementations, the out-of-dictionary indicator can be provided based on a sequence of events and/or actions. For example, in some implementations, a sequence of one or more user interactions with a touchscreen and shape-writing user interface can be tracked by a computing device to determine if a word or other text is not included in a text suggestion dictionary for use with shape writing on the computing device and if an out-of-dictionary indicator is to be provided. In some implementations, an out-of-dictionary indicator can be triggered based on the deleting of recommended text entered for a shape-writing shape. The deleting of the text can be determined to be a failed recognition event which can indicate that the recognition of the shape-writing shape failed by a shape-writing recognition engine. In some implementations, there can be a check to determine if there were at least two consecutive failed recognition events and a comparison to determine that the shape-writing shapes entered are similar shape-writing shapes before providing an out-of-dictionary indicator. In some implementations, text can be added to a text suggestion dictionary responsive at least in part to the text being entered into a text edit field after an out-of-dictionary indicator has been provided.

### Exemplary System for Providing at Least One Out-of-Dictionary Indicator Based at Least on Comparing Received Shape-Writing Shapes

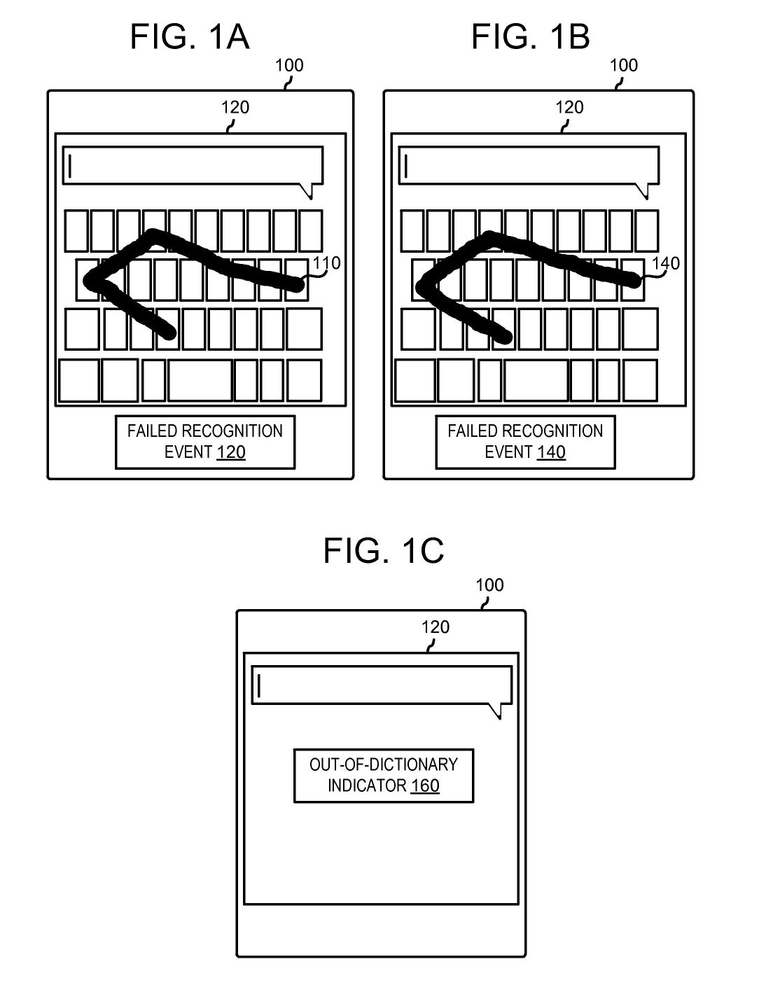

FIGS. 1A, 1B and 1C are diagrams of an exemplary computing device 100 that can provide at least one out-of-dictionary indicator based at least in part on comparing received shape-writing shapes. In FIG. 1A, a first shape-writing shape 110 is received by a touchscreen 120 of the computing device 100 from a user and a determination is made that a failed recognition event 130 has occurred for the first shape-writing shape 110. In some implementations, a shape-writing recognition engine cannot recognize a shape-writing shape as representing an out-of-dictionary text such as a word or other text that is not included in a text suggestion dictionary for the shape-writing recognition engine. In some implementations, a shape-writing recognition engine can fail to recognize a shape-writing shape representing an out-of-dictionary word by providing wrong recognition candidate text and/or by treating the shape-writing shape as an invalid shape. In some implementations, the failed recognition event 130 can be a deleting of text recognized for the first shape-writing shape that is recommended by automatic entry into a text edit field. For example, the first shape-writing shape can be recognized by a shape-writing recognition engine to be a word and the word is automatically entered in to the text edit field as recognized text. The recognized text can then be deleted by a user from the text edit field. In another implementation, the failed recognition event 130 can be a failure to recognize the first shape-writing shape 110 as a valid shape. For example, a shape-writing recognition engine can fail to recognize the first shape-writing shape 110 as a valid shape-writing shape and provide no recommended text based on the first shape-writing shape 110.

In FIG. 1B, after the failed recognition event 130 illustrated in FIG. 1A, a second shape-writing shape 140 is received by the touchscreen 120 of the computing device 100 from the user and a determination is made that a failed recognition event 150 has occurred for the second shape-writing shape 140.

In FIG. 1C, after the failed recognition event 150 illustrated in FIG. 1B, the first shape-writing shape 110 illustrated in FIG. 1A is compared to the second shape-writing shape 140 illustrated in FIG. 1B. For example, the first shape-writing shape 110 can be compared to the second shape-writing shape 140 to determine if the first and second shape-writing shapes are similar or not similar. Based on the comparing of the first shape-writing shape 110 and the second shape-writing shape 140, at least one out-of-dictionary indicator 160 is provided by the computing device 100. For example, if the first and second shape-writing shapes are determined to be similar by the comparison, the at least one out-of-dictionary indicator can be provided. In some implementations, the at least one out-of-dictionary indicator 160 can be a visual out-of-dictionary indicator, an audio out-of-dictionary indicator, or a haptic out-of-dictionary indicator.

In some cases of shape writing, a user may not know that the text they are trying to enter into a computing device is out-of-dictionary text which can be a word or other text that is not included in a text suggestion dictionary, for the shape-writing recognition engine of the computing device, for use as text for text recommendations. In some implementations, one or more out-of-dictionary indicators can be provided by the computing device to indicate that one or more shape-writing shapes entered by the user represent text that is out-of-dictionary text.

### Exemplary Method for Providing at Least One Out-of-Dictionary Indicator Based at Least on Comparing Received Shape-Writing Shapes

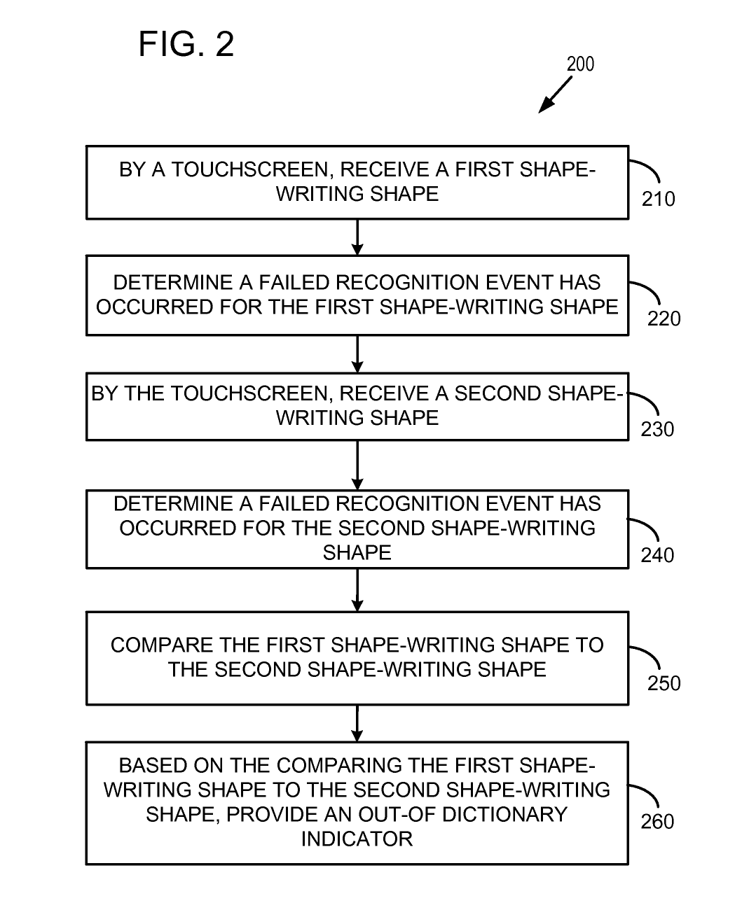

FIG. 2 is a flow diagram of an exemplary method 200 for providing at least one out-of-dictionary indicator based at least in part on comparing received shape-writing shapes. In some implementations of shape writing, a user can write a word or other text by entering a shape-writing shape, via a touchscreen, into shape-writing user interface. In some implementations, a shape-writing shape gesture can be performed on a touchscreen and the corresponding shape-writing shape can be received by the touchscreen. In some implementations, the shape-writing shape gesture can include a continuous stroke that maintains contact with the touchscreen from the beginning of the stroke to the end of the stroke. In some implementations, the continuous stroke can continue in one or more directions. In some implementations, the continuous stroke can pause in moving across the touchscreen while maintaining contact with the touchscreen. In some implementations, the shape-writing shape gesture traces one or more on-screen keyboard keys corresponding to the one or more characters in a word or other text. For example, the shape-writing shape corresponding to the shape-writing shape gesture can trace one or more on-screen keyboard keys in an order based on the order that the corresponding one or more characters in the word or other text are arranged.

In FIG. 2, by a touchscreen, a first shape-writing shape is received at 210. For example, an on-screen keyboard can be displayed by the touchscreen and a user can contact the touchscreen to generate the first shape-writing shape corresponding to one or more keys of the on-screen keyboard. In some implementations, a shape-writing shape connects one or more keys of the on-screen keyboard. For example, the shape-writing shape can be received by the touchscreen such that the shape-writing shape connects one or more keys of the on-screen keyboard in an order. The order can be based on the order the keys are connected by the shape-writing shape as the shape is received by the touchscreen. In some implementations of receiving a shape-writing shape, at least a portion of the shape-writing shape can be displayed by the touchscreen. In another implementation of receiving a shape-writing shape, the shape-writing shape is not displayed by the touchscreen. In some implementations, receiving a shape-writing shape can include receiving shape-writing information by a touchscreen that is caused to be contacted by a user. In some implementations, the shape-writing shape can be received by the touchscreen by dragging contact with the touchscreen relative to (e.g., on, overlapping, near to, through, across, or the like) the locations of one or more keys displayed for the on-screen keyboard. In some implementations, the shape-writing shape can be received according to a shape-writing user interface for entering text into one or more applications and/or software. In some implementations, a shape-writing shape can be rendered and/or displayed in the touch screen. For example, a trace of at least a portion of the shape-writing shape can be rendered and/or displayed in the touchscreen. In other implementations, a trace of the shape-writing shape and/or at least a portion of the shape-writing shape is not displayed in the touchscreen.

At 220, it is determined that a failed recognition event has occurred for the first shape-writing shape. For example, the first shape-writing shape can be evaluated by a shape-writing recognition engine and the shape-writing recognition engine can fail to recognize the first shape-writing shape or the shape-writing recognition engine can recognize the first shape-writing shape incorrectly. In some implementations of a failed recognition event for a shape-writing shape, the shape-writing recognition engine can fail to recognize the shape-writing shape as a valid shape. For example, the shape-writing recognition engine can handle the shape-writing shape as a shape that is not valid and/or not included in a text suggestion dictionary used by the shape-writing recognition engine. In some implementations, responsive to receiving a shape-writing shape, the shape-writing recognition engine fails to recognize the shape-writing shape as a valid shape-writing shape and can provide no recommendations of text for the shape-writing shape. In some implementations of a failed recognition event for a shape-writing shape, a shape-writing recognition engine can recognize the shape-writing shape and recommend recognized text that is incorrectly recognized text. For example, the shape-writing shape can be recognized as text that is automatically recommended and the recommended recognized text can be deleted. The deleting of the recommended recognized text can be an indication that the recognition of the shape-writing shape failed.

At 230, by the touchscreen, a second shape-writing shape is received. For example, the on-screen keyboard can be displayed by the touchscreen and after the failed recognition event for the first shape-writing shape, the user can contact the touchscreen to generate the second shape-writing shape corresponding to one or more keys of the on-screen keyboard. The second shape-writing shape can be entered and/or received by the touchscreen.

At 240, a failed recognition event is determined to have occurred for the second shape-writing shape. For example, the second shape-writing shape can be evaluated by a shape-writing recognition engine and the shape-writing recognition engine can fail to recognize the second shape-writing shape as a valid shape or recognized text automatically entered for the second shape-writing shape can be deleted.

At 250, the first shape-writing shape is compared to the second shape-writing shape. For example, responsive to the failed recognition event for the second shape-writing shape, the first shape-writing shape can be compared to the second shape-writing shape by a shape-writing recognition engine. In some implementations, the comparing of the first and second shape-writing shapes can be used to determine that the first shape-writing shape is similar or is not similar to the second shape-writing shape. For example, during the comparing a measure of the similarity of the first and second shape-writing shapes can be determined. The first and second shape-writing shapes can be compared using shape-writing recognition techniques. In some implementations, the measure of similarity between the first and second shape writing shape can be determined using one or more techniques such as dynamic time warping, nearest neighbor classification, Rubine classification, or the like. For example, a shape-writing recognition engine can compare the first and second shape-writing shapes to determine if the first and second shape-writing shapes are similar in shape or if the first and second shape-writing shapes are not similar in shape.

In some implementations, the measure of similarity can be compared to a threshold value for similarity. If the measure of similarity satisfies the threshold value then the first shape-writing shape can be determined to be similar and/or substantially similar to the second shape-writing shape. In contrast, if the measure of similarity does not satisfy the threshold value then the first shape-writing shape can be determined not to be similar and/or substantially similar to the second shape-writing shape.

At 260, an out-of-dictionary indicator is provided based at least in part on the comparing the first shape-writing shape to the second shape-writing shape. For example, the first shape-writing shape can be compared to the second shape-writing shape and determined to be similar to the second shape-writing shape. Based on the determination that the first shape-writing shape is similar to the second shape-writing shape, an out-of-dictionary indicator can be provided. In some implementations, the providing the at least one out-of-dictionary indicator can be based at least in part on a determination that at least one out-of-dictionary attempt has occurred. For example, a classifier, such as a machine learned classifier, can determine that one or more out-of-dictionary attempts has occurred. In some implementations, an out-of-dictionary attempt can include an attempt to enter text, at least by entering one or more shape-writing shapes, which is not recognized by the shape-writing recognition engine because the text is not included in one or more text suggestion dictionaries used by the shape-writing recognition engine of the computing device. In some implementations, the classifier can determine that at least one out-of-dictionary attempt has occurred based at least in part on considering one or more of a similarity of the first and second shape-writing shapes, a determination that the second shape-writing shape is entered and/or received slower than the first shape-writing shape, one or more words (e.g., two words or other number of words) included in the text edit field previous to an entry point for text to be entered, probabilities of one or more text candidates given the previous two words included in the text edit field, or other considerations. In some implementations of a text candidate, the shape-writing recognition engine can provide text as candidates based on the first and/or second shape-writing shape. In some implementations, the text candidates can be associated with probabilities based on the two previous words included in the text edit field. In some implementations of a determination that at least one out-of-dictionary attempt has occurred for a shape-writing shape, a shape-writing recognition engine can assign a probability, as a measure of recognition accuracy, to one or more recognized text candidates based on the entered shape writing shape. Based on the probabilities, assigned to the one or more recognized text candidates, the text-recognition engine can determine at least one out-of-dictionary attempt has occurred. In some implementations, a probability assigned to a recognized text candidate for a shape-writing shape can be compared to a probability threshold, and if the assigned probability does not satisfy the probability threshold, a determination can be made that at least one out-of-dictionary attempt has occurred for the shape-writing shape. For example, a recognized text candidate for a shape-writing shape can be assigned a 10% probability as a measure of recognition accuracy, and the 10% probability can be compared to a probability threshold set at 70% or other percentage, and the 10% probability can be determined to not meet the probability threshold because the 10% probability is lower than the set probability threshold.

The out-of-dictionary indicator can indicate that the input first and second shape-writing shapes are not recognizable as text included in the text suggestion dictionary for the shape-writing recognition engine. The out-of-dictionary indicator can prompt for text to be entered and/or input using a different manner than shape-writing recognition. In some implementations, text can be entered and/or input into a text edit field by typing the text using a keyboard. For example, the text can be received through a user interface such as an on-screen keyboard. A user can enter the text by tapping the corresponding keys of the on-screen keyboard and the on-screen keyboard user interface can detect the contact with the touchscreen and enter the appropriate text into the text edit field. In some implementations, other user interfaces can be used to enter the text such as a physical keyboard or the like. In some implementations, text (e.g. entered text, recognized text, or other text) can include one or more letters, numbers, characters, words, or combinations thereof.

### Exemplary System Providing Out-of-Dictionary Indicators

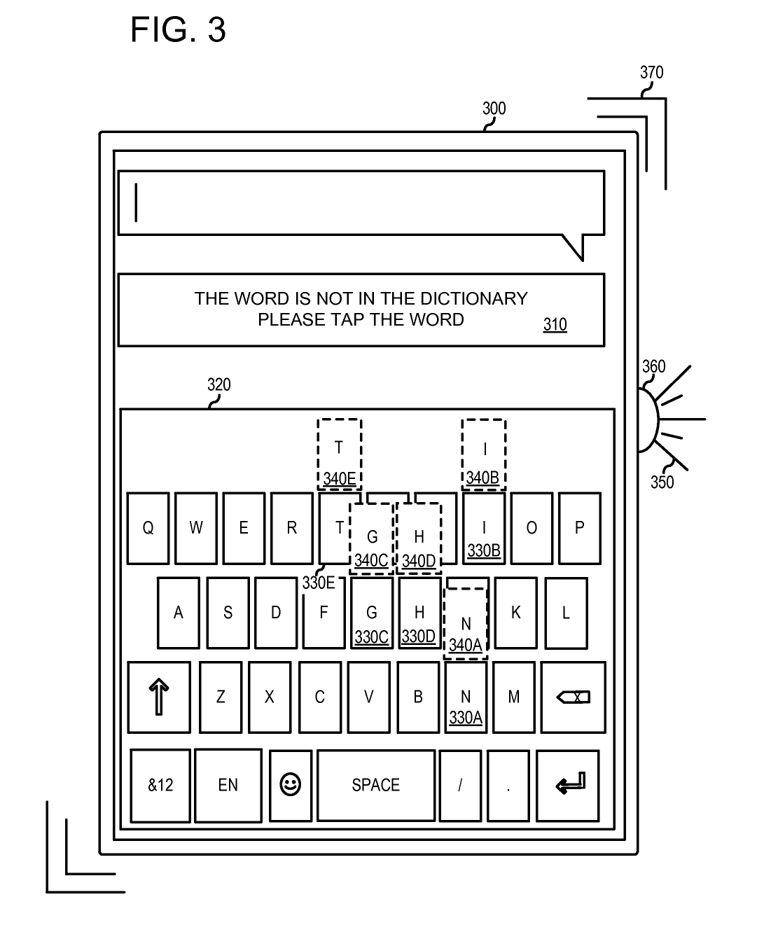

FIG. 3 is a diagram of an exemplary computing device 300 providing out-of-dictionary indicators. In FIG. 3, the computing device 300 can provide out-of-dictionary indicators such as a visual out-of-dictionary indicator, an audio out-of-dictionary indicator, or a haptic out-of-dictionary indicator. The one or more visual out-of-dictionary indicators provided by the computing device 300 can include a text-entry direction message such as text-entry direction message 310. A text-entry direction message can include displayed text that indicates to enter text in a different manner than using shape writing. The text-entry direction message 310 displays the text “PLEASE TAP THE WORD” which indicates that a word can be entered by typing the word by tapping on the on-screen keyboard 320. The text-entry direction message 310 can be a prompt to notify a user to enter the word unrecognized by shape writing by tapping the word out on the on-screen keyboard instead of using a shape-writing shape for shape writing. In some implementations, the text-entry direction message 310 can include displayed text which indicates that the word the user is trying to enter is not in one or more text suggestion dictionaries for the shape-writing engine of computing device 300.

The one or more visual out-of-dictionary indicators provided by the computing device 300 can include one or more accented keys of the on-screen keyboard 320. In some implementations, the one or more keys which are included as accented in the visual out-of-dictionary indicator can be selected based on an entered shape-writing shape. For example, a shape-writing shape that was followed by a failed recognition event can be used to select at least one of the one or more keys to be accented for the visual out-of-dictionary indicator. The one or more keys selected for accenting for the visual out-of-dictionary indicator can be keys that are associated with the shape-writing shape on the on-screen keyboard 320. In some implementations, the shape-writing shape can be entered as contacting the touchscreen in relation to and/or on one or more of the displayed keys that are accented for the visual out-of-dictionary indicator. In some implementations, one or more of the keys that are displayed as accented can be determined to have been paused on during the entering and/or receiving of a shape-writing shape. For example, while performing a shape-writing shape gesture to enter a shape-writing shape, the user can pause the dragging of contact with the touchscreen, while maintaining contact with the touchscreen, causing the contact to overlap a key displayed in the touchscreen, and that key can be determined to have been paused on and then displayed as accented as part of an out-of-dictionary indicator. In some implementations, at least one key can be selected to be an accented key based on a determination that the at least one key was paused on longer than at least one other key during the entering and/or receiving of the shape writing shape.

In FIG. 3, the visual out-of-dictionary indicator includes the keys 330A-330E which are accented by displayed bubbling of the keys as shown by bubbled keys 340A-340E. The key 330A is accented by bubbled key 340A. The key 330B is accented by bubbled key 340B. The key 330C is accented by bubbled key 340C. The key 330D is accented by bubbled key 340D. The key 330E is accented by bubbled key 340E. In some implementations, a key can be accented by highlighting the key, changing the color of the key, changing the shape of the key, or otherwise changing the manner in which the key is displayed.

The one or more audio out-of-dictionary indicators provided by the computing device 300 can include one or more audio signals. For example, an audio signal can include a signal that produces a sound, music, a recorded message, or the like. In some implementations, an audio signal can be generated using one or more speakers of the computing device 300. In FIG. 3, an audio out-of-dictionary indicator 350 is produced using a speaker 360 of the computing device 300.

The one or more haptic out-of-dictionary indicators provided by the computing device 300 can include a vibrating of the computing device 300 as illustrated at 370.

### Exemplary System for Adding Entered Text to a Text Suggestion Dictionary after Providing at Least One Out-of-Dictionary Indicator

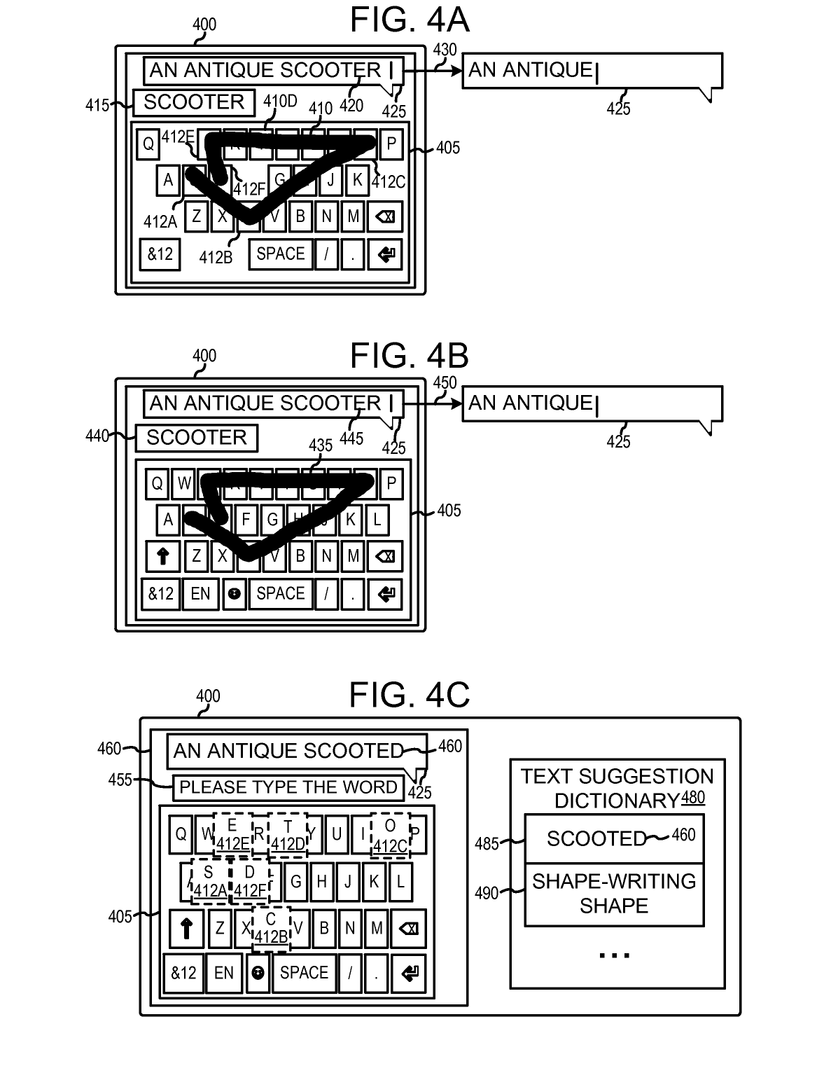

FIGS. 4A, 4B, and 4C are diagrams of an exemplary computing device 400 that can add entered text to a text suggestion dictionary for shape-writing recognition after providing at least one out-of-dictionary indicator. In FIG. 4A, the computing device 400 receives a shape-writing shape 410 by the on-screen keyboard 405 and recognizes the shape-writing shape 410 to produce the text recommendation 415 and automatically entering the word “SCOOTER” as recognized text 420 into the text edit field 425. Some of the keys of the on-screen keyboard 405 are not shown in FIG. 4A, however, in some implementations, the keys can be displayed, by the computing device 400, as included in the on-screen keyboard 405.

To enter the shape-writing shape 410 a user causes contact (e.g., via contacting with a finger, a stylus, or other object) with the touchscreen over the displayed “S” key 412A, while maintaining contact with the touchscreen the user slides the contact to the “C” key 412B. Then, while continuing to maintain the contact with the touchscreen, the user slides the contact to the “O” key 412C. Then while maintaining the contact with the touchscreen, the user slides the contact across the “T” key 412D to the “E” key 412E. The contact is maintained with the touchscreen while the user slides the contact from the “E” key 412E to the “D” key 412F. After the contact slides to the “D” key 412F the user breaks the contact with the touch screen. For example, the user can lift up a finger or other object creating contact with the touch screen to break the contact with the touch screen. The shape-writing shape 410 can be analyzed by a shape-writing recognition engine which recognizes the recognized text 420 as associated text for recommendation based on the entered shape-writing shape 410. Then, the recognized text 420 is automatically entered into the text edit field. One or more text recommendations, such as text recommendation 415, can be displayed in the touch screen display as alternative text recognized as associated with the shape-writing shape. For example, recommended and/or recognized text can be associated with the a shape-writing shape by a shape-writing recognition engine determining that the shape-writing shape is likely to represent the recommended and/or recognized text.

After the recognized text 420 is automatically entered into the text edit field 425, a failed recognition event is determined to have occurred, as shown at 430, after the automatically entered recognized text 420 is deleted from the text edit field 425. In some implementations, a text edit field can be a field of a software and/or application where text can be entered into, deleted from, or otherwise edited.

In FIG. 4B, the computing device 400 receives a shape-writing shape 435 and recognizes the shape-writing shape 435 to produce the text recommendation 440 and automatically entering the word “SCOOTER” as recognized text 445 into the text edit field 425. Then a failed recognition event is determined to have occurred for the shape-writing shape 435, as shown at 450, after the automatically entered recognized text 445 is deleted from the text edit field 425. The failed recognition event for the shape-writing shape 410 of FIG. 4A and the failed recognition event for the shape-writing shape of FIG. 4B can be consecutive failed recognition events as the failed recognition events occurred responsive to consecutively entered and/or received shape-writing shapes.

In FIG. 4C, responsive to determining the consecutive failed recognition events of FIGS. 4A and 4B have occurred, the computing device 400 compares the shape-writing shape 410 as illustrated in FIG. 4A with the shape-writing shape 435 as illustrated in FIG. 4B to determine the shape-writing shape 410 is similar to shape-writing shape 435. Additionally, responsive to determining that the shape 410 is similar to shape-writing shape 435, the computing device 400 provides one or more out-of-dictionary indicators. In FIG. 4C, the out-of-dictionary indicator 455 includes a text-entry direction message that reads “PLEASE TYPE THE WORD” to prompt a user to enter the desired text by typing the desired text using the on-screen keyboard 405 displayed by the touchscreen 460. In FIG. 4C, the touchscreen displays a visual out-of-dictionary indicator which includes the accenting of the keys 412A, 412B, 412C, 412D, 412E, and 412F. The accented keys 412A-412F are highlighted based on their association with the shape-writing shape 410 as illustrated in FIG. 4A and/or shape-writing shape 435 as illustrated in FIG. 4B, and in some implementations can aid a user in locating the keys for typing text using the on-screen keyboard 405. For example, the keys can be accented for use in the out-of-dictionary indicator because the keys were traced by the shape-writing shape 410 and/or the shape-writing shape 435. In some implementations, one or more of the keys that are displayed as accented can be determined to have been paused on during the entering and/or receiving of the shape-writing shape 410 and/or the shape-writing shape 435. Also, after determining that the shape 410 is similar to shape-writing shape 435 and/or the providing of the out-of-dictionary indicators such as the out-of dictionary indicator 455, the text 460 which is the word “SCOOTED” is typed using the on-screen keyboard 405 and entered in the text edit field 425. Responsive to the text 460 being determined to be the first text entered in the text edit field 425 after the determination that the shape 410 is similar to shape-writing shape 435 and/or the providing of the out-of-dictionary indicators such as the out-of dictionary indicator 455, the text 460 is added to the text suggestion dictionary 480 as shown at 485. In some implementations, the text 460 can be added to the text suggestion dictionary 480 for the shape-writing recognition engine of computing device 400 so that the text 460 can be used as a recommendation if the shape-writing recognition engine recognizes a shape-writing shape as associated with the text 460.

The text 460 as included in text suggestion dictionary 480 can be associated with one or more shape-writing shapes such as the shape-writing shape 410 or shape-writing shape 435 that resulted in a failed recognition event and triggered the one or more out-of-dictionary indicators that were produced to prompt the entry of the text 460. The text suggestion dictionary 480 can be any text suggestion dictionary described herein. In some implementations, a text suggestion dictionary can be a dictionary that includes at least one text that can be recommended by a shape-writing recognition engine when a shape-writing shape is recognized as associated with the at least one text by the shape-writing recognition engine.

### Exemplary System for Adding Entered Text to a Text Suggestion Dictionary after Providing at Least One Out-of-Dictionary Indicator and then Recommending the Entered Text as a Text Recommendation

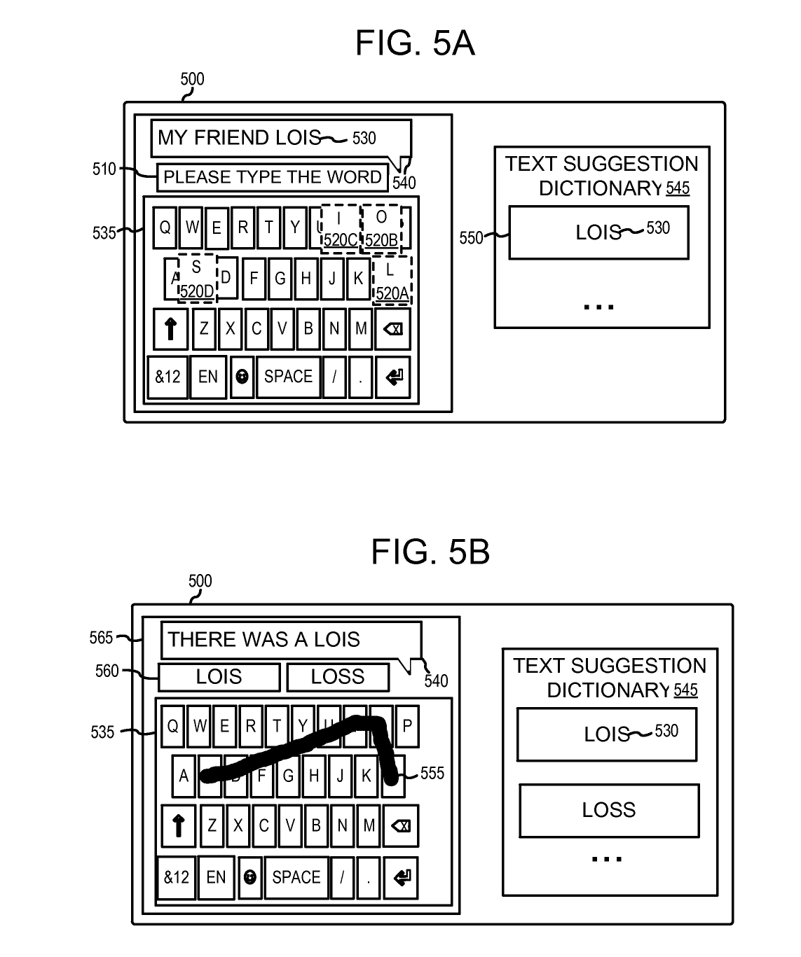

FIGS. 5A and 5B are diagrams of an exemplary computing device 500 that can add entered text into a text suggestion dictionary for shape-writing recognition after providing at least one out-of-dictionary indicator and then recommending the entered text as a text recommendation. In FIG. 5A, after determining that failed recognition events have occurred for consecutively entered shape-writing shapes, the computing device 500 compares the first and consecutive shape-writing shapes to determine that the first and consecutive shape-writing shapes are similar. Responsive to the determination that the first and consecutive shape-writing shapes are similar, the computing device 500 provides one or more out-of-dictionary indicators such as visual out-of-dictionary indicator 510 and a visual out-of-dictionary indicator that includes the highlighted on-screen keyboard keys 520A, 520B, 520C, 520D. Also, after determining that the first and consecutive shape-writing shapes are similar and/or the providing of the one or more out-of-dictionary indicators such as the out-of dictionary indicator 510, the text 530 which is the name “LOIS” is typed using the on-screen keyboard 535 and the text 530 is entered in the text edit field 540. Responsive to the entered text 530 being determined to be the first text entered in the text edit field 540 after the determination that the entered first and consecutive shape-writing shapes are similar and/or the providing of the one or more out-of-dictionary indicators, the text 530 is added to the text suggestion dictionary 545 as shown at 550.

In FIG. 5B, a shape-writing shape 555 is received by the on-screen keyboard 535 of the computing device 500. The shape-writing shape 555 is processed by the shape-writing recognition engine of the computing device 500 and the shape-writing shape 555 is recognized as the text 530 that is included in the text suggestion dictionary 545 of the computing device 500. Responsive to being recognized, the text 530 is provided in a text recommendation 560 and/or automatically entered into the text edit field 540 as displayed by the touchscreen display 565.

### Exemplary System for Providing at Least One Out-of-Dictionary Indicator after at Least One Failed Recognition Event and Adding Entered Text to a Text Suggestion Dictionary

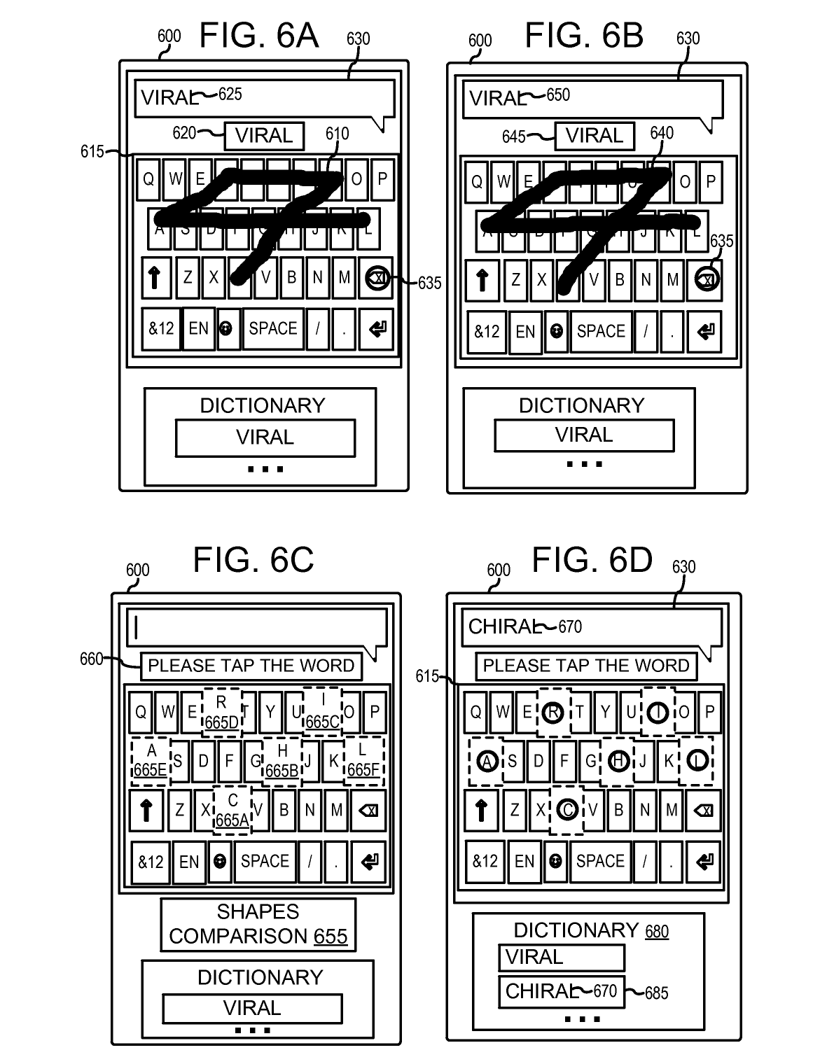

FIGS. 6A, 6B, 6C, and 6D are diagrams of an exemplary computing device 600 for providing at least one out-of-dictionary indicator after at least one failed recognition event and adding entered text to a text suggestion dictionary. In FIG. 6A, the computing device 600 receives a shape-writing shape 610 by the on-screen keyboard 615 and recognizes the shape-writing shape 610 to produce the text recommendation 620 and automatically entering the word “VIRAL” as recognized text 625 into the text edit field 630. Then the automatically entered recognized text 625 is deleted from the text edit field 630 by deleting functionality 635, and the deleting of the recognized text 625 is determined to be a failed recognition event for the shape-writing shape 610. In some implementations, text can be deleted using a delete key of the on-screen keyboard, or other deleting functionality that can delete text from a text edit field.

In FIG. 6B, after receiving the shape-writing shape 610 as illustrated in FIG. 6A, the computing device 600 receives a subsequent shape-writing shape 640 and recognizes the shape-writing shape 640 to produce the text recommendation 645 and automatically entering the word “VIRAL” as recognized text 650 into the text edit field 630. Then the automatically entered recognized text 650 is deleted from the text edit field 630 by deleting functionality 635, and the deleting of the recognized text 650 is determined to be an occurrence of a failed recognition event for the shape-writing shape 640.

In FIG. 6C, responsive to the determining of the failed recognition event for the shape-writing shape 640 as illustrated by FIG. 6B has occurred as a consecutive failed recognition event, the computing device 600 compares the shape-writing shape 610 as illustrated in FIG. 6A with the shape-writing shape 640 as illustrated in FIG. 6B to determine the shape-writing shape 610 is similar to shape-writing shape 640 as illustrated at 655. Additionally, responsive to determining that the shape 610 is similar to shape-writing shape 640, one or more out-of-dictionary indicators are provided by the computing device 600 such as the visual out-of-dictionary indicator 660 and/or the visual out-of-dictionary indicator that includes the accented on-screen keyboard keys 665A, 665B, 665C, 665D, 665E, and 665F. In some implementations, the on-screen keyboard keys that are accented as part of an out-of-dictionary indicator can be associated with a shape-writing shape for which a failed recognition event has occurred. For example, one or more of the accented on-screen keyboard keys can be selected as having been at least connected by a trace of the shape-writing shape or otherwise associated with the shape-writing shape.

In FIG. 6D, after determining that the shape 610 is similar to shape-writing shape 640 and/or the providing of the out-of-dictionary indicators as illustrated in FIG. 6C, the text 670, which is the word “CHIRAL,” is typed using the on-screen keyboard 615 and entered in the text edit field 630. Responsive to the text 670 being determined to be the first text entered in the text edit field 630 after the determination that the shape-writing shape 610 is similar to shape-writing shape 640 and/or the providing of the out-of-dictionary indicators as illustrated in FIG. 6C, the text 670 is added to the text suggestion dictionary 680 as shown at 685.

### Exemplary Method for Providing at Least One Out-of-Dictionary Indicator and Adding Entered Text to a Text Suggestion Dictionary

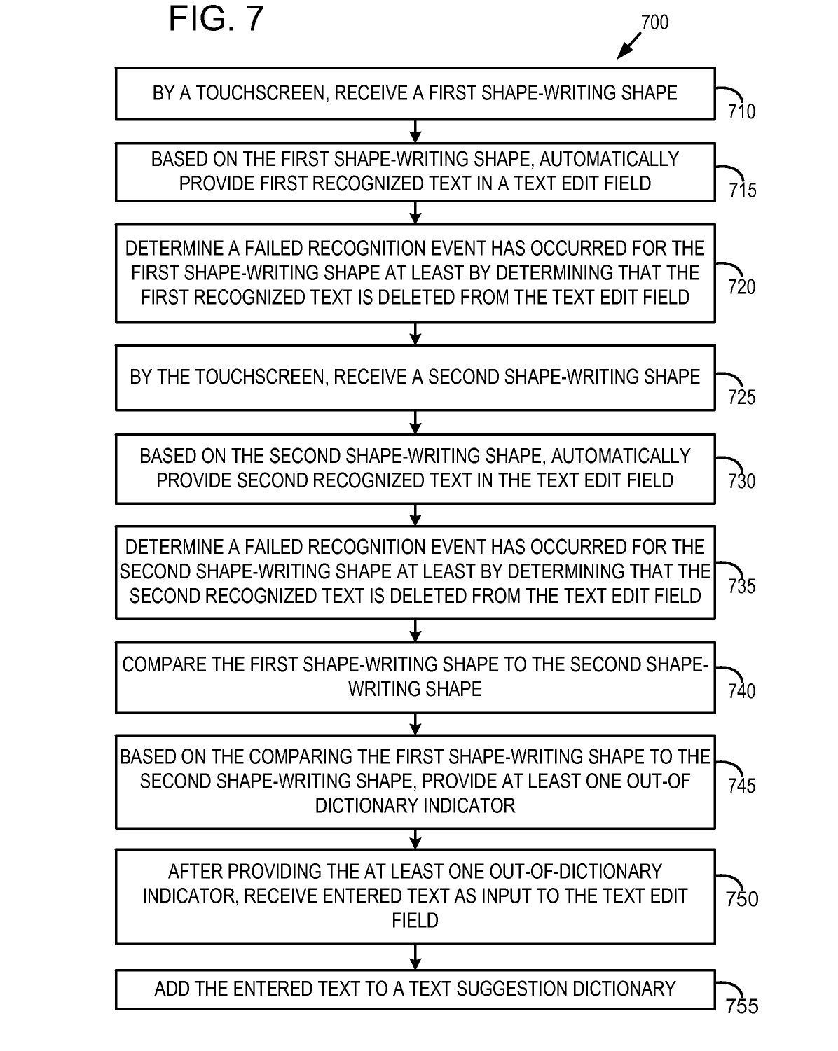

FIG. 7 is a flow diagram of an exemplary method 700 for providing at least one out-of-dictionary indicator and adding entered text to a text suggestion dictionary. In FIG. 7, by a touchscreen, a first shape-writing shape is received at 710. For example, a user produces a shape-writing shape by contacting the on-screen keyboard displayed in a touchscreen and information for the shape-writing shape is received. In some implementations, the information for the received shape-writing shape can be stored in one or memory stores.

At 715, first recognized text is automatically provided in a text edit field based on the first shape-writing shape. For example, a shape-writing recognition engine recognizes the shape-writing shape as associated with text included in a text suggestion dictionary for the shape-writing recognition engine and automatically enters the recognized text into a text edit field included in the touch screen display.

At 720, it is determined that a failed recognition event has occurred for the first shape-writing shape at least by determining that the first recognized text is deleted from the text edit field. For example, after the recognized text is automatically entered into the text edit field, the user can use a user interface functionality to delete the automatically entered text from the text edit field. The deleting of the automatically entered text can be determined to have occurred as a failed recognition event. The deleting of the text can be an indicator that the automatically entered text was not a correct recognition of the entered shape-writing shape.

At 725, by the touchscreen, a second shape-writing shape is received. For example, after deleting the text recognized for the first shape-writing shape and before additional text is added to the text edit field, a user produces a second shape-writing shape by contacting the on-screen keyboard displayed in the touchscreen and information for the second shape-writing shape is received. In some implementations, the information for the received second shape-writing shape can be stored in one or more memory stores.

At 730, second recognized text is automatically provided in the text edit field based on the second shape-writing shape. For example, the shape-writing recognition engine recognizes the second shape-writing shape as associated with text included in a text suggestion dictionary for the shape-writing recognition engine and automatically enters the recognized text into the text edit field displayed by the touchscreen.

At 735, it is determined that a failed recognition event has occurred for the second shape-writing shape at least by determining that the second recognized text is deleted from the text edit field. For example, after the text recognized for the second shape-writing shape is automatically entered into the text edit field, the user can use a user interface functionality to delete the automatically entered text from the text edit field. The deleting of the automatically entered text can be determined to have occurred as a failed recognition event for the second shape-writing shape. The deleting of the text can be an indicator that the automatically entered text was not a correct recognition of the entered second shape-writing shape. In some implementations, the failed recognition event for the first shape-writing shape can be a first failed recognition event and the failed recognition event for the second shape-writing shape can be a second failed recognition event. For example, a first failed recognition event can occur and a consecutive second failed recognition event can occur. The second failed recognition event can occur as a consecutive failed recognition event when the second shape-writing shape is received by the touchscreen after the first failed recognition event and before additional text is entered into the text edit field after the first failed recognition event. In some implementations, a count of consecutive failed recognition events can be maintained.

At 740, the first shape-writing shape is compared to the second shape-writing shape. For example, the first shape-writing shape is compared to the second shape-writing shape to determine if the first shape-writing shape is a similar or not similar shape-writing shape to the second shape-writing shape. In some implementations, based on the comparison of the first and second shape-writing shapes, the first and second shape-writing shapes can be determined to be similar. In other implementations, based on the comparison of the first and second shape-writing shapes, the first and second shape-writing shapes can be determine to be not similar.

At 745, at least one out-of-dictionary indicator is provided based at least in part on the comparing the first shape-writing shape to the second shape-writing shape. For example, if the first shape-writing shape is determined to be similar to the second shape-writing shape by the comparison, then at least one out-of-dictionary indicators can be provided responsive to the determination that the first and second shape-writing shapes are similar shape-writing shapes. Alternatively, if the second shape-writing shape is determined not to be similar to the second shape-writing shape, then no out-of-dictionary indicators are provided responsive to the determination that the first and second shape-writing shapes are not similar shape-writing shapes. The at least one out-of-dictionary indicator which is provided can be any out-of-dictionary indicator described herein.

At 750, entered text is received as input to the text edit field after the comparing of the first shape-writing shape to the second shape-writing shape. For example, after the providing of the at least one out-of dictionary indicator, text is entered and received as input into the text edit field using a user interface that is not a shape-writing recognition user interface.

In some implementations, a shape-writing recognition user interface can be a user interface that can enter text, such as a word or other text, into a program or application based on recognition of shape-writing shapes.

The text can be received, by the touchscreen, a keyboard, or other user interface. In some implementations, a user contacts (e.g., via typing on, tapping, or the like) the touchscreen to select one or more keys of an on-screen keyboard (e.g., a virtual keyboard or the like) that correspond and/or produce the characters of the text so that the text can be entered and displayed into the text edit field. For example, a user can type the text into the text edit field using the on-screen keyboard.

At 755, the entered text is added to a text suggestion dictionary. For example responsive to the entered text being entered into the text edit field, the entered text is added to the text suggestion dictionary for the shape-writing recognition engine. In some implementations, the entered text is added to a text suggestion dictionary based on a determination that the entered text is the first text added into the text edit field following the comparing of the first shape-writing shape with the second shape-writing shape and/or the providing of the at least one out-of-dictionary indicator.

### Exemplary Mobile Device

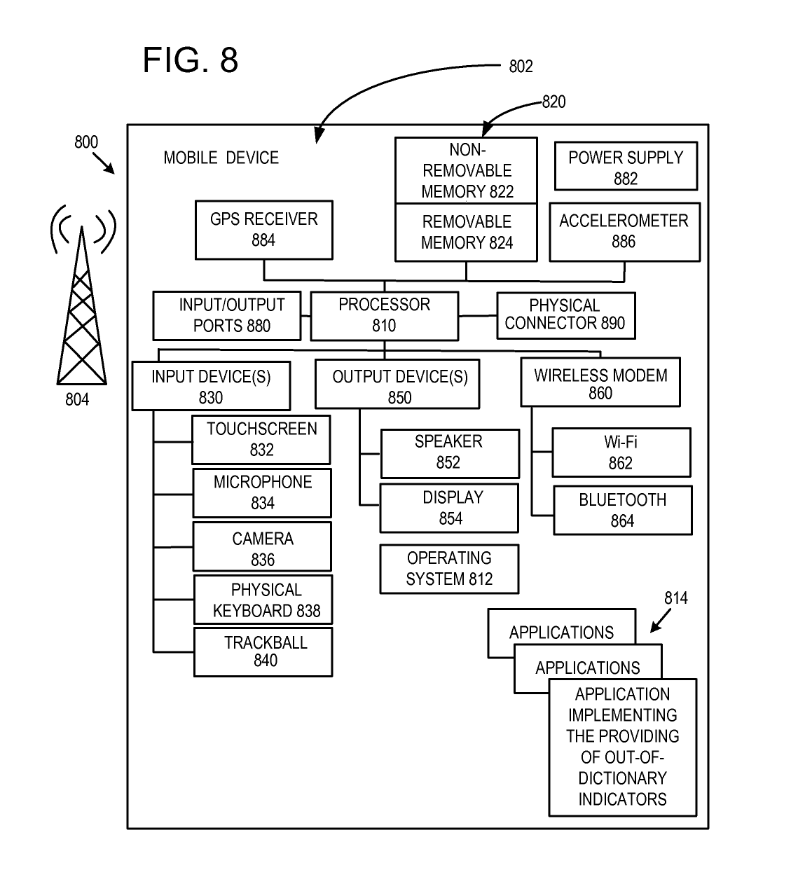

FIG. 8 is a system diagram depicting an exemplary mobile device 800 including a variety of optional hardware and software components, shown generally at 802. Any components 802 in the mobile device can communicate with any other component, although not all connections are shown, for ease of illustration. The mobile device can be any of a variety of computing devices (e.g., cell phone, smartphone, handheld computer, tablet computer, Personal Digital Assistant (PDA), etc.) and can allow wireless two-way communications with one or more mobile communications networks 804, such as a cellular or satellite network.

The illustrated mobile device 800 can include a controller or processor 810 (e.g., signal processor, microprocessor, ASIC, or other control and processing logic circuitry) for performing such tasks as signal coding, data processing, input/output processing, power control, and/or other functions. An operating system 812 can control the allocation and usage of the components 802 and support for one or more application programs 814 such as an application program that can implement one or more of the technologies described herein for providing one or more out-of-dictionary indicators. The application programs can include common mobile computing applications (e.g., email applications, calendars, contact managers, web browsers, messaging applications), or any other computing application.

The illustrated mobile device 800 can include memory 820. Memory 820 can include non-removable memory 822 and/or removable memory 824. The non-removable memory 822 can include RAM, ROM, flash memory, a hard disk, or other well-known memory storage technologies. The removable memory 824 can include flash memory or a Subscriber Identity Module (SIM) card, which is well known in GSM communication systems, or other well-known memory storage technologies, such as “smart cards.” The memory 820 can be used for storing data and/or code for running the operating system 812 and the applications 814. Example data can include web pages, text, images, sound files, video data, or other data sets to be sent to and/or received from one or more network servers or other devices via one or more wired or wireless networks. The memory 820 can be used to store a subscriber identifier, such as an International Mobile Subscriber Identity (IMSI), and an equipment identifier, such as an International Mobile Equipment Identifier (IMEI). Such identifiers can be transmitted to a network server to identify users and equipment.

The mobile device 800 can support one or more input devices 830, such as a touchscreen 832, microphone 834, camera 836, physical keyboard 838 and/or trackball 840 and one or more output devices 850, such as a speaker 852 and a display 854. Other possible output devices (not shown) can include piezoelectric or other haptic output devices. Some devices can serve more than one input/output function. For example, touchscreen 832 and display 854 can be combined in a single input/output device. The input devices 830 can include a Natural User Interface (NUI). An NUI is any interface technology that enables a user to interact with a device in a “natural” manner, free from artificial constraints imposed by input devices such as mice, keyboards, remote controls, and the like. Examples of NUI methods include those relying on speech recognition, touch and stylus recognition, gesture recognition both on screen and adjacent to the screen, air gestures, head and eye tracking, voice and speech, vision, touch, gestures, and machine intelligence. Other examples of a NUI include motion gesture detection using accelerometers/gyroscopes, facial recognition, 3D displays, head, eye, and gaze tracking, immersive augmented reality and virtual reality systems, all of which provide a more natural interface, as well as technologies for sensing brain activity using electric field sensing electrodes (EEG and related methods). Thus, in one specific example, the operating system 812 or applications 814 can comprise speech-recognition software as part of a voice user interface that allows a user to operate the device 800 via voice commands. Further, the device 800 can comprise input devices and software that allows for user interaction via a user's spatial gestures, such as detecting and interpreting gestures to provide input to a gaming application.

A wireless modem 860 can be coupled to an antenna (not shown) and can support two-way communications between the processor 810 and external devices, as is well understood in the art. The modem 860 is shown generically and can include a cellular modem for communicating with the mobile communication network 804 and/or other radio-based modems (e.g., Bluetooth 864 or Wi-Fi 862). The wireless modem 860 is typically configured for communication with one or more cellular networks, such as a GSM network for data and voice communications within a single cellular network, between cellular networks, or between the mobile device and a public switched telephone network (PSTN).

The mobile device can further include at least one input/output port 880, a power supply 882, a satellite navigation system receiver 884, such as a Global Positioning System (GPS) receiver, an accelerometer 886, and/or a physical connector 890, which can be a USB port, IEEE 1394 (FireWire) port, and/or RS-232 port. The illustrated components 802 are not required or all-inclusive, as any components can be deleted and other components can be added.

### Exemplary Implementation Environment

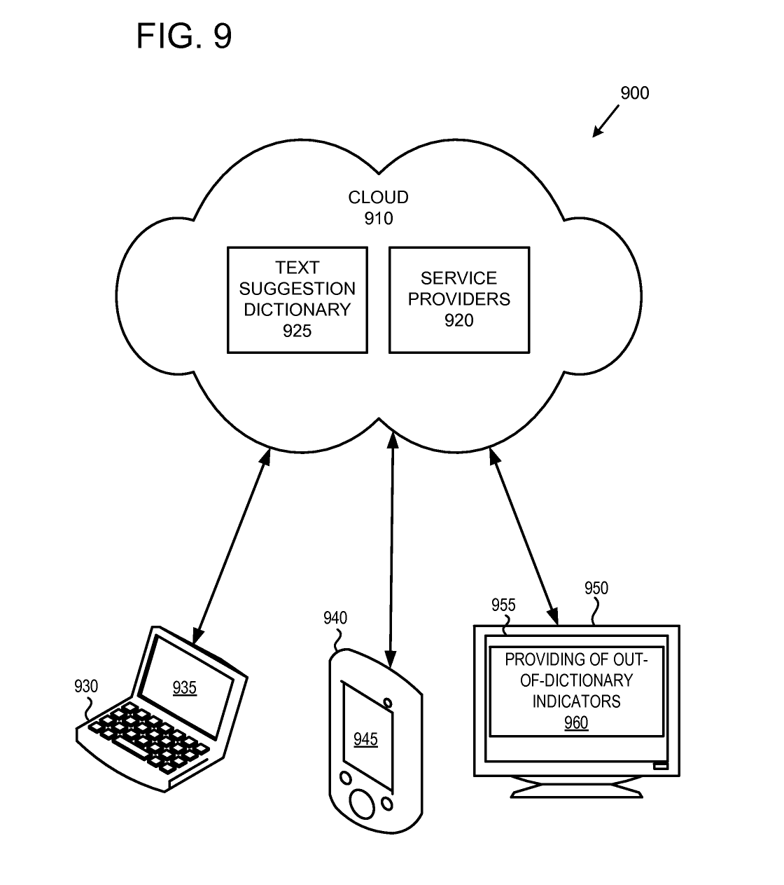

FIG. 9 illustrates a generalized example of a suitable implementation environment 900 in which described embodiments, techniques, and technologies may be implemented.

In example environment 900, various types of services (e.g., computing services) are provided by a cloud 910. For example, the cloud 910 can comprise a collection of computing devices, which may be located centrally or distributed, that provide cloud-based services to various types of users and devices connected via a network such as the Internet. The implementation environment 900 can be used in different ways to accomplish computing tasks. For example, some tasks (e.g., processing user input and presenting a user interface) can be performed on local computing devices (e.g., connected devices 930, 940, 950) while other tasks (e.g., storage of data to be used in subsequent processing) can be performed in the cloud 910.

In example environment 900, the cloud 910 provides services for connected devices 930, 940, 950 with a variety of screen capabilities. Connected device 930 represents a device with a computer screen 935 (e.g., a mid-size screen). For example, connected device 930 could be a personal computer such as desktop computer, laptop, notebook, netbook, or the like. Connected device 940 represents a device with a mobile device screen 945 (e.g., a small size screen). For example, connected device 940 could be a mobile phone, smart phone, personal digital assistant, tablet computer, or the like. Connected device 950 represents a device with a large screen 955. For example, connected device 950 could be a television screen (e.g., a smart television) or another device connected to a television (e.g., a set-top box or gaming console) or the like. One or more of the connected devices 930, 940, 950 can include touchscreen capabilities. Touchscreens can accept input in different ways. For example, capacitive touchscreens detect touch input when an object (e.g., a fingertip or stylus) distorts or interrupts an electrical current running across the surface. As another example, touchscreens can use optical sensors to detect touch input when beams from the optical sensors are interrupted. Physical contact with the surface of the screen is not necessary for input to be detected by some touchscreens. Devices without screen capabilities also can be used in example environment 900. For example, the cloud 910 can provide services for one or more computers (e.g., server computers) without displays.

Services can be provided by the cloud 910 through service providers 920, or through other providers of online services (not depicted). For example, cloud services can be customized to the screen size, display capability, and/or touchscreen capability of a particular connected device (e.g., connected devices 930, 940, 950).

In example environment 900, the cloud 910 provides the technologies and solutions described herein to the various connected devices 930, 940, 950 using, at least in part, the service providers 920. For example, the service providers 920 can provide a centralized solution for various cloud-based services. The service providers 920 can manage service subscriptions for users and/or devices (e.g., for the connected devices 930, 940, 950 and/or their respective users). The cloud 910 can provide one or more text suggestion dictionaries 925 to the various connected devices 930, 940, 950. For example, the cloud 910 can provide one or more text suggestion dictionaries to the connected device 950 for the connected device 950 to implement provide out-of-dictionary indicators as illustrated at 960.

### Exemplary Computing Environment

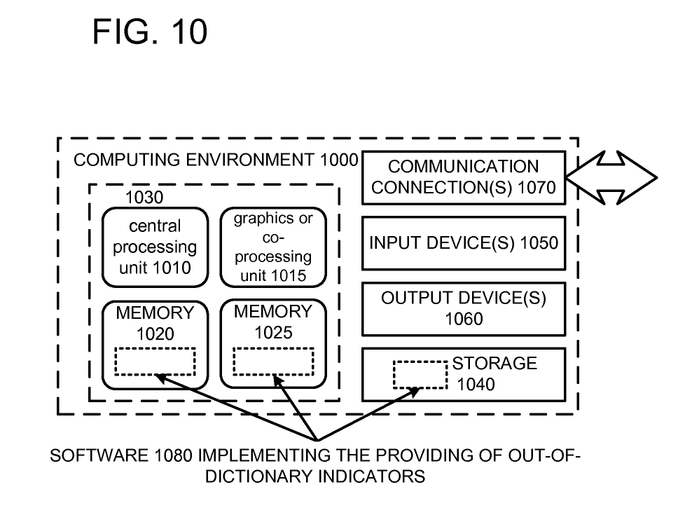

FIG. 10 depicts a generalized example of a suitable computing environment 1000 in which the described innovations may be implemented. The computing environment 1000 is not intended to suggest any limitation as to scope of use or functionality, as the innovations may be implemented in diverse general-purpose or special-purpose computing systems. For example, the computing environment 1000 can be any of a variety of computing devices (e.g., desktop computer, laptop computer, server computer, tablet computer, media player, gaming system, mobile device, etc.).

With reference to FIG. 10, the computing environment 1000 includes one or more processing units 1010, 1015 and memory 1020, 1025. In FIG. 10, this basic configuration 1030 is included within a dashed line. The processing units 1010, 1015 execute computer-executable instructions. A processing unit can be a general-purpose central processing unit (CPU), processor in an application-specific integrated circuit (ASIC) or any other type of processor. In a multi-processing system, multiple processing units execute computer-executable instructions to increase processing power. For example, FIG. 10 shows a central processing unit 1010 as well as a graphics processing unit or co-processing unit 1015. The tangible memory 1020, 1025 may be volatile memory (e.g., registers, cache, RAM), non-volatile memory (e.g., ROM, EEPROM, flash memory, etc.), or some combination of the two, accessible by the processing unit(s). The memory 1020, 1025 stores software 1080 implementing one or more innovations described herein, in the form of computer-executable instructions suitable for execution by the processing unit(s).

A computing system may have additional features. For example, the computing environment 1000 includes storage 1040, one or more input devices 1050, one or more output devices 1060, and one or more communication connections 1070. An interconnection mechanism (not shown) such as a bus, controller, or network interconnects the components of the computing environment 1000. Typically, operating system software (not shown) provides an operating environment for other software executing in the computing environment 1000, and coordinates activities of the components of the computing environment 1000.

The tangible storage 1040 may be removable or non-removable, and includes magnetic disks, flash drives, magnetic tapes or cassettes, CD-ROMs, DVDs, or any other medium which can be accessed within the computing environment 1000. The storage 1040 stores instructions for the software 1080 implementing one or more innovations described herein such as software that implements the providing of one or more out-of-dictionary indicators.

The input device(s) 1050 may be an input device such as a keyboard, touchscreen, mouse, pen, or trackball, a voice input device, a scanning device, or another device that provides input to the computing environment 1000. For video encoding, the input device(s) 1050 may be a camera, video card, TV tuner card, or similar device that accepts video input in analog or digital form, or a CD-ROM or CD-RW that reads video samples into the computing environment 1000. The output device(s) 1060 may be a display, printer, speaker, CD-writer, or another device that provides output from the computing environment 1000.

The communication connection(s) 1070 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions stored on one or more computer-readable storage media (e.g., one or more optical media discs, volatile memory components (such as DRAM or SRAM), or nonvolatile memory components (such as flash memory or hard drives)) and executed on a computer (e.g., any commercially available computer, including smart phones or other mobile devices that include computing hardware). The term computer-readable storage media does not include communication connections, such as signals and carrier waves. Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Perl, JavaScript, Adobe Flash, or any other suitable programming language. Likewise, the disclosed technology is not limited to any particular computer or type of hardware. Certain details of suitable computers and hardware are well known and need not be set forth in detail in this disclosure.

It should also be well understood that any functionality described herein can be performed, at least in part, by one or more hardware logic components, instead of software. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and subcombinations with one another. The disclosed methods, apparatus, and systems are not limited to any specific aspect or feature or combination thereof, nor do the disclosed embodiments require that any one or more specific advantages be present or problems be solved.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope of these claims.

We claim:

1. One or more computer-readable storage media storing computer-executable instructions for causing a computing system to perform a method, the method comprising:
receiving, by a touchscreen, a first shape-writing shape;
determining a failed recognition event has occurred for the first shape-writing shape;
receiving, by the touchscreen, a second shape-writing shape;
determining a failed recognition event has occurred for the second shape-writing shape;
comparing the first shape-writing shape to the second shape-writing shape; and
based on the comparing the first shape-writing shape to the second shape-writing shape, providing at least one out-of-dictionary indicator.

2. The one or more computer-readable storage media of claim 1, further comprising:
based on the comparing the first shape-writing shape to the second shape-writing shape, determining that the first shape-writing shape is substantially similar to the second shape-writing shape.

3. The one or more computer-readable storage media of claim 2, further comprising:
after the determining that the first shape-writing shape is substantially similar to the second shape-writing shape, receiving entered text in a text edit field; and
adding the entered text to a text suggestion dictionary.

4. The one or more computer-readable storage media of claim 1, further comprising:
based on the first shape-writing shape, automatically providing recognized text in a text edit field; and
wherein the determining the failed recognition event has occurred for the first shape-writing shape comprises determining the recognized text in the text edit field is deleted from the text edit field.

5. The one or more computer-readable storage media of claim 3, wherein the recognized text is first recognized text and the method further comprising:
based on the second shape-writing shape, automatically providing second recognized text in a text edit field; and
wherein the determining the failed recognition event has occurred for the second shape-writing shape comprises determining the second recognized text is deleted from the text edit field.

6. The one or more computer-readable storage media of claim 3, further comprising wherein the entered text is received at least by determining that one or more keyboard keys have been tapped.

7. The one or more computer-readable storage media of claim 1, wherein the providing the at least one out-of-dictionary indicator comprises displaying a visual out-of-dictionary indicator, the visual out-of-dictionary indicator comprising a text-entry direction message.

8. The one or more computer-readable storage media of claim 1, wherein the providing the at least one out-of-dictionary indicator comprises displaying one or more accented keys included in an on-screen keyboard based at least on the first shape-writing shape or the second shape-writing shape.

9. The one or more computer-readable storage media of claim 1, wherein the providing the at least one out-of-dictionary indicator comprises providing an audio out-of-dictionary indicator or a haptic out-of-dictionary indicator.

10. The one or more computer-readable storage media of claim 2, further comprising:
receiving, by the touchscreen, a third shape-writing shape;
recognizing the third shape-writing shape as corresponding to a shape-writing shape stored for the entered text of the text suggestion dictionary; and
providing the entered text as a text recommendation from the text suggestion dictionary based on the recognizing the third shape-writing shape as corresponding to the shape-writing shape stored for the entered text of the text suggestion dictionary.

11. The one or more computer-readable storage media of claim 2, further comprising:
after the determining that the first shape-writing shape is substantially similar to the second shape-writing shape, receiving entered text in the text edit field; and
adding the entered text to a text suggestion dictionary;
wherein the determining the failed recognition event has occurred for the first shape-writing shape comprises determining that the first shape-writing shape is not recognized based on shape-writing recognition of the first shape-writing shape; and
wherein the determining a failed recognition event has occurred for the second shape-writing shape comprises determining that the second shape-writing shape is not recognized based on shape-writing recognition of the second shape-writing shape.

12. The one or more computer-readable storage media of claim 1, wherein the providing the at least one out-of-dictionary indicator is further based at least in part on a determination, by a classifier, that an out-of-dictionary attempt has occurred.

13. A method comprising:
receiving, by a touchscreen, a first shape-writing shape;
determining a failed recognition event has occurred for the first shape-writing shape;
receiving, by the touchscreen, a second shape-writing shape;
determining a failed recognition event has occurred for the second shape-writing shape;
comparing the first shape-writing shape to the second shape-writing shape; and
based on the comparing that the first shape-writing shape to the second shape-writing shape, displaying a visual out-of-dictionary indicator.

14. The method of claim 13 further comprising:
based on the first shape-writing shape, automatically providing first recognized text in a text edit field;
wherein the determining the failed recognition event has occurred for the first shape-writing shape comprises determining the first recognized text is deleted from the text edit field;
based on the second shape-writing shape, automatically providing second recognized text in the text edit field; and
wherein the determining the failed recognition event has occurred for the second shape-writing shape comprises determining the second recognized text is deleted from the text edit field.

15. The method of claim 13 further comprising:
after the comparing the first shape-writing shape to the second shape-writing shape, receiving entered text in a text edit field; and
adding the entered text into a text suggestion dictionary.

16. The method of claim 15, wherein the entered text is received at least by receiving a typing of the entered text on a keyboard.

17. The method of claim 13 further comprising:
wherein the displaying the at least one visual out-of-dictionary indicator comprises displaying a text-entry direction message.

18. The method of claim 13, wherein the displaying the at least one visual out-of-dictionary indicator comprises displaying one or more accented keys included in an on-screen keyboard based at least in part on a determination that the one or more accented keys were paused on during the receiving of the first shape-writing shape or the second shape-writing shape.

19. The method of claim 13 further comprising:
based on the comparing the first shape-writing shape to the second shape-writing shape, providing an audio out-of-dictionary indicator or a haptic out-of-dictionary indicator.

20. A computing device comprising at least one processor and memory, the memory storing computer-executable instructions for causing the computing device to perform a method, the method comprising:
receiving, by a touchscreen, a first shape-writing shape;
based on the first shape-writing shape, automatically providing first recognized text in a text edit field;
determining a failed recognition event has occurred for the first shape-writing shape at least by determining the first recognized text is deleted from the text edit field;
receiving, by the touchscreen, a second shape-writing shape;
based on the second shape-writing shape, automatically providing second recognized text in the text edit field;
determining a failed recognition event has occurred for the second shape-writing shape at least by determining the second recognized text is deleted from the text edit field;
comparing the first shape-writing shape with the second shape-writing shape;
based on the comparing the first shape-writing shape to the second shape-writing shape, providing at least one visual out-of-dictionary indicator in the touchscreen of the computing device;
after comparing that the first shape-writing shape to the second shape-writing shape, receiving entered text as input to the text edit field; and
adding the entered text to a text suggestion dictionary.
